(19) United States
(12) Patent Application Publication
(10) Pub. No.: US 2015/0047515 A1
(43) Pub. Date: Feb. 19, 2015

(54) HEAT TRANSFER COOKING ACCESSORY

(71) Applicant: Fairchild Products LLC, Fox Point, WI (US)

(72) Inventor: Ryan Thomas Jenness, Fox Point, WI (US)

(21) Appl. No.: 14/458,618

(22) Filed: Aug. 13, 2014

Related U.S. Application Data
(60) Provisional application No. 61/959,002, filed on Aug. 13, 2013.

(51) Int. Cl. A47J 37/07

(52) U.S. Cl. CPC A47J 37/0786
USPC 99/445; 29/890.03

(57) ABSTRACT

A cooking accessory includes a cooking receptacle. The cooking accessory is configured to be selectively coupled to a rim of a cooking appliance. The cooking receptacle defines a cooking cavity. The cooking cavity is configured to receive food. The cooking receptacle includes an opening and a conductive side surface that is configured to substantially abut an outer surface of the cooking appliance. The conductive side surface substantially enables thermal energy transfer from the cooking appliance to the cooking cavity. The food within the cooking cavity is configured to absorb a portion of the thermal energy. The cooking accessory may also include a lid selectively removable from the cooking receptacle. The lid substantially contains the thermal energy within the cooking receptacle when the lid is coupled to the cooking receptacle.

### CROSS-REFERENCE TO RELATED APPLICATIONS

This application claims priority to U.S. Provisional Patent Application No. 61/959,002 filed Aug. 13, 2013, the entire contents of which are incorporated by reference herein.

### BACKGROUND

Cooking accessories are utilized to cook, heat up, or maintain temperature of various food items (e.g., hot dogs, bratwurst, hamburgers, beans, etc.). It is advantageous to keep the food items at an appropriate elevated temperature without the assistance of an electrical and/or gas operable cooking accessory because electricity and/or fuel gas may not be available to a user (e.g., when the user is at a barbecue, a tailgate at a sporting event, or camping outdoors). Conventionally, users store cooked or heated food items on a plate or serving dish which exposes the food items to external variables (e.g., ambient temperature, moisture, etc.) that may render the cooked or heated food items undesirable (e.g., cold and/or dry). Furthermore, the more time the food items are exposed to the external variables, the more undesirable the food items become. In addition, the more time the food items are below optimal temperature, the more susceptible the food items are to bacteria growth.

### SUMMARY

In one embodiment, a cooking accessory is configured to be selectively coupled to a rim of a cooking appliance. The cooking accessory includes a cooking receptacle configured to physically couple to an exterior of the cooking appliance. The cooking receptacle defines a cooking cavity. The cooking cavity is configured to receive food. The cooking receptacle includes an opening, a bottom, and a conductive side surface configured to abut the outer surface of the cooking appliance. The conductive side surface enabling thermal energy transfer from the cooking appliance to the cooking cavity. The food within the cooking cavity is configured to absorb a portion of the thermal energy. The cooking accessory also includes a lid selectively removable from the cooking receptacle. The lid containing the thermal energy within the cooking receptacle when the lid is coupled to the cooking receptacle.

In another embodiment, a cooking accessory includes an opening and an outer surface configured to abut an outer surface of a cooking appliance. The outer surface receives thermal energy from the cooking appliance. The outer surface includes a hanging member configured to selectively couple the cooking accessory to the cooking appliance. The cooking accessory also includes an inner surface configured to transfer thermal energy from the outer surface to food.

In still another embodiment, a method enables thermal energy transfer from a cooking appliance to a cooking accessory. The cooking accessory includes a conductive side surface. The method includes providing a cooking cavity defined within the cooking accessory. The cooking cavity is configured to receive food. The method also includes physically coupling the cooking accessory to the cooking appliance so that the conductive side surface abuts an outer surface of the cooking appliance, wherein the cooking accessory is thermally dependent on thermal energy of the cooking appliance. The method further includes enabling thermal energy transfer from the cooking appliance to the cooking cavity substantially through the conductive side surface.

Other aspects of the invention will become apparent by consideration of the detailed description and accompanying drawings.

### BRIEF DESCRIPTION OF THE DRAWINGS

FIG. 1A is a perspective view of a cooking accessory coupled to a hemispherical cooking appliance according to one embodiment.

FIG. 1B is a perspective view of a cooking accessory coupled to a cuboid cooking appliance according to another embodiment.

FIG. 1C is a perspective view of the cooking accessory of FIG. 1A coupled to the hemispherical cooking appliance in a different manner.

FIG. 2 is an exploded view of the cooking accessory of FIG. 1A.

FIG. 3 is a perspective view of the cooking accessory of FIG. 1A including a cooking receptacle and a lid.

FIG. 4 is an exploded view of the cooking accessory of FIG. 3.

FIG. 5 is a front view of the cooking accessory of FIG. 1A.

FIG. 6 is a back view of the cooking accessory of FIG. 1A.

FIG. 7 is a side view of the cooking accessory of FIG. 1A.

FIG. 8 is a top view of the cooking accessory of FIG. 1A.

FIG. 9 is a bottom view of the cooking accessory of FIG. 1A.

FIG. 10 is a front view of a lid of the cooking accessory of FIGS. 1A or 1B.

FIG. 11 is a back view of the lid of FIG. 10.

FIG. 12 is a side view of the lid of FIG. 10.

FIG. 13 is a top view of the lid of FIG. 10.

FIG. 14 is a bottom view of the lid of FIG. 10.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

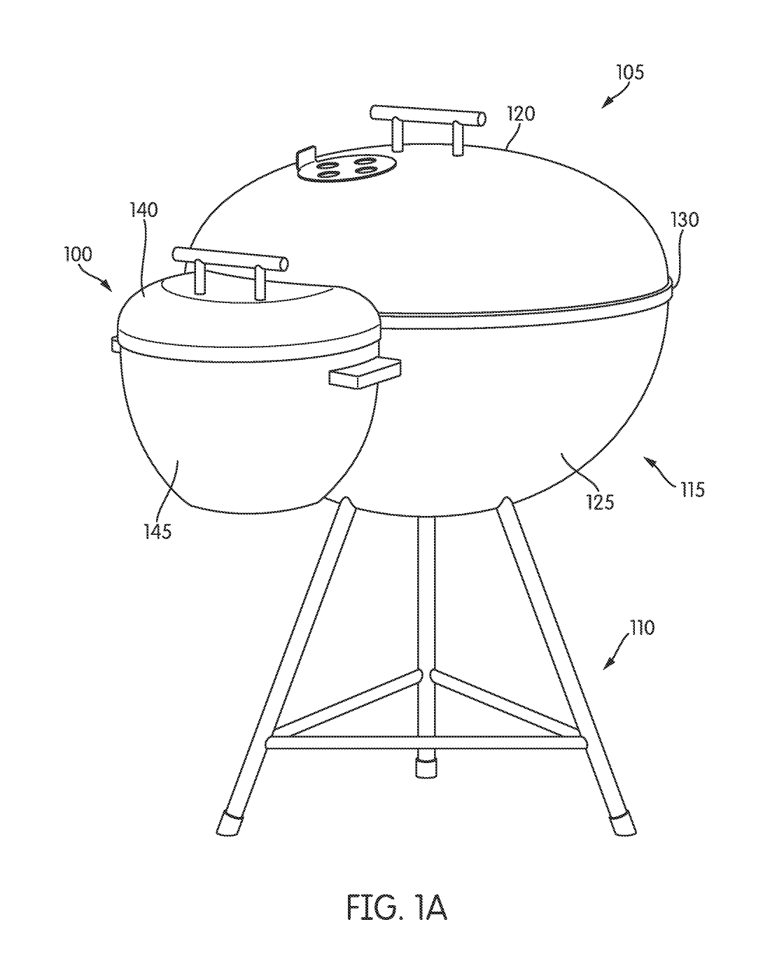

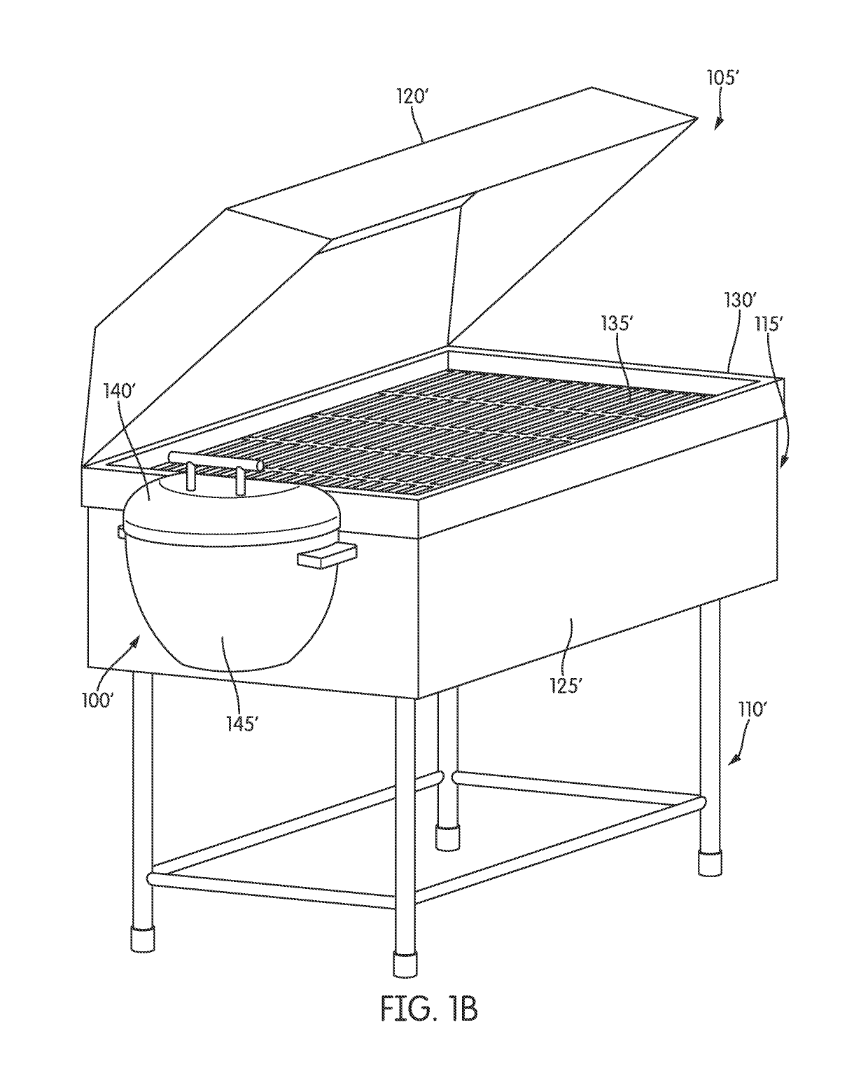

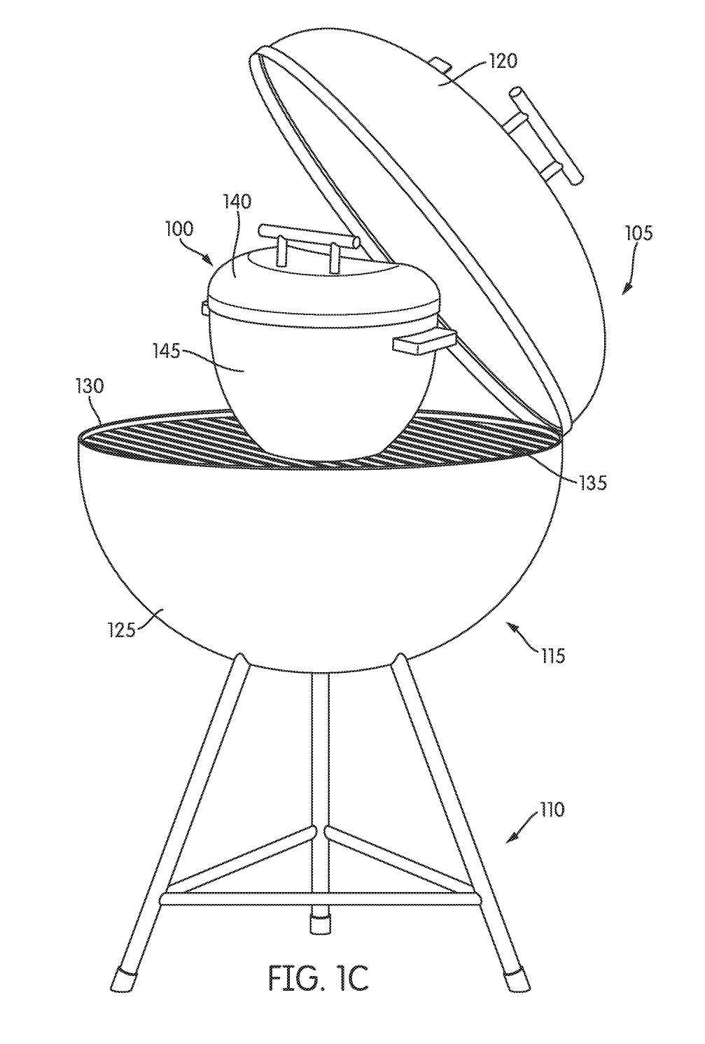

FIG. 1A illustrates a cooking accessory 100 coupled to a cooking appliance 105. The cooking appliance 105 may be any apparatus that produces thermal energy to heat and/or cook food (e.g., a grill). In the illustrated embodiment, the cooking appliance 105 is a conventional charcoal grill. In other embodiments, the cooking appliance 105 may be operable by wood or by a fuel gas such as propane and the like. The cooking appliance 105 includes a support structure 110 that supports a base 115 and a cover 120 that is selectively removable from the base 115.

The base 115 supports a heat source (e.g., charcoal, wood, fuel gas). In the illustrated embodiment, the base 115 defines a substantially hemispherical structure including an exterior surface 125 and a rim 130. The rim 130 extends around a top periphery of the base 115 adjacent the cover 120 when the cover 120 is coupled to the base 115. Consequently, the rim 130 is substantially defined in a circular geometry. In addition, the cover 120 is completely removable from the base 115.

FIG. 1B illustrates the cooking accessory 100′ coupled to a second cooking appliance 105′. The cooking appliance 105′ includes a base 115′, which defines a substantially cuboid structure. Consequently, the rim 130′ of base 115′ is substantially defined in a rectangular geometry, and the exterior surface 125′ is substantially planar. In this embodiment, the cover 120′ may be pivotally coupled to the base 115′. In other embodiments, the cooking appliance 105 may have a rim 130 which includes a circular portion and a straight portion. In such an embodiment, the cooking appliance 105 may have a rim 130 which is generally defined as a letter “D” shape. Further in such an embodiment, the circular portion may have a radius approximately greater than two hundred and seventy degrees, while the straight portion defines the remaining chord of the rim 130.

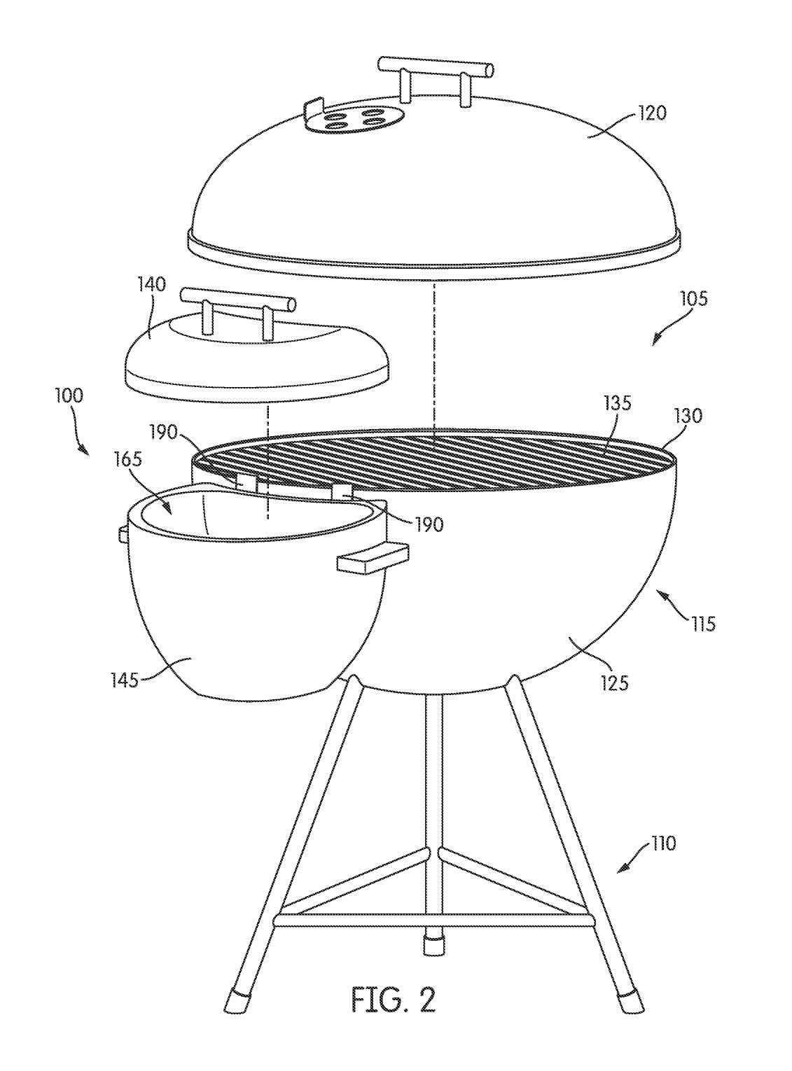

In reference to FIGS. 1B, 1C, and 2, the cooking appliance 105, 105′ also includes an appliance grate 135, 135′. The appliance grate 135, 135′ includes an outer periphery generally including the same geometry to the rim 130, 130′. The appliance grate 135, 135′ is located within the base 115, 115′ near the rim 130, 130′. The appliance grate 135, 135′ is a surface that is located above the heat source able to support food.

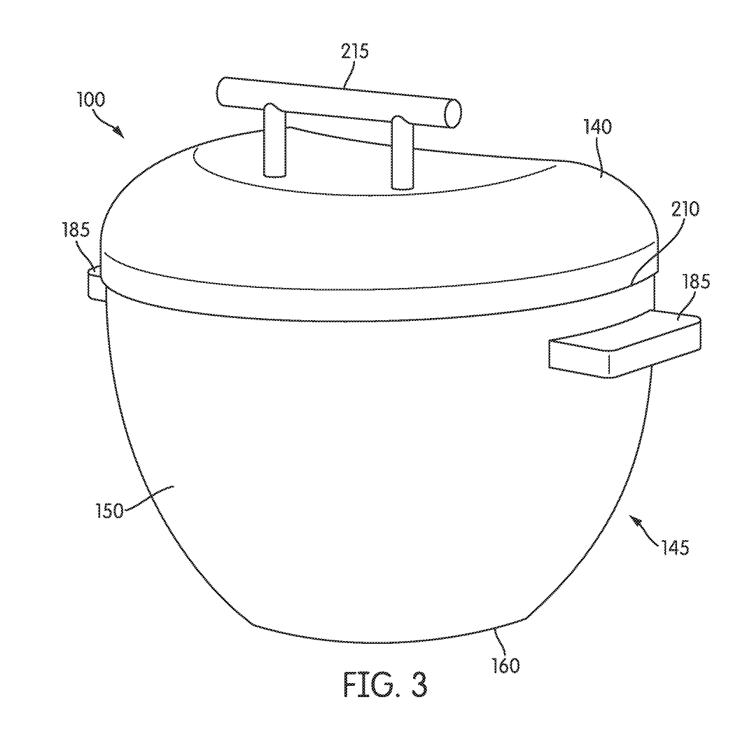

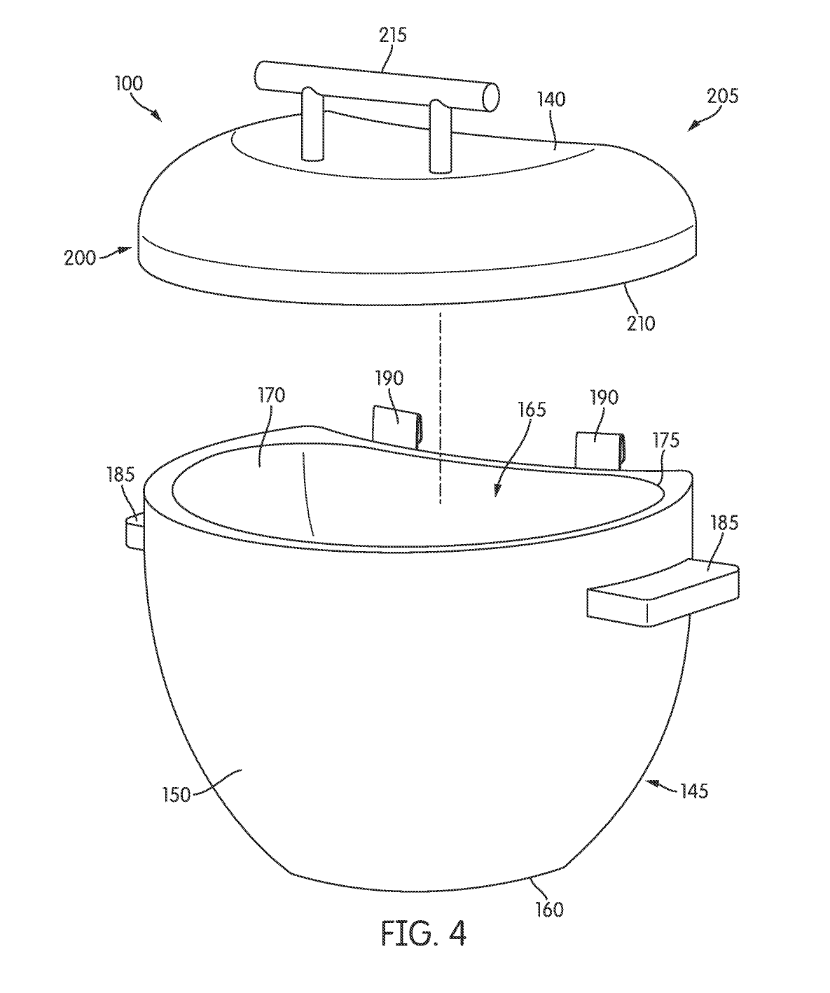

FIGS. 3 and 4 illustrate the cooking accessory 100 including a lid 140 and a cooking receptacle 145. The lid 140 is selectively received on the cooking receptacle 145.

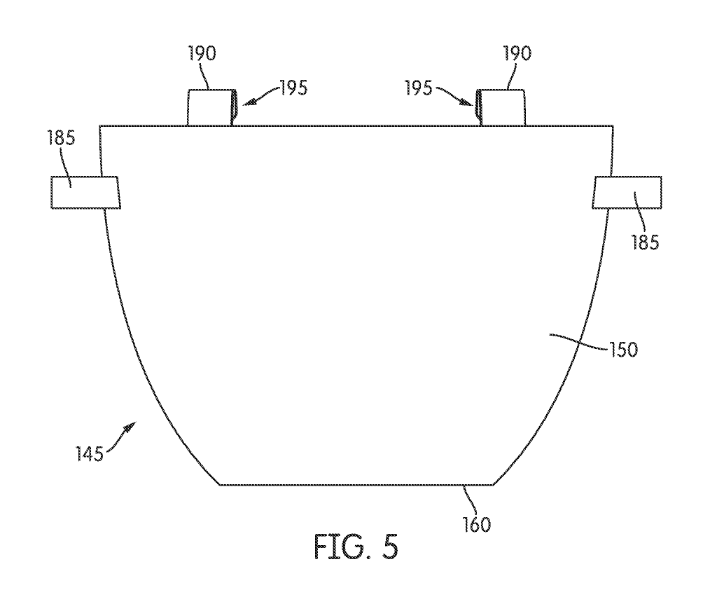

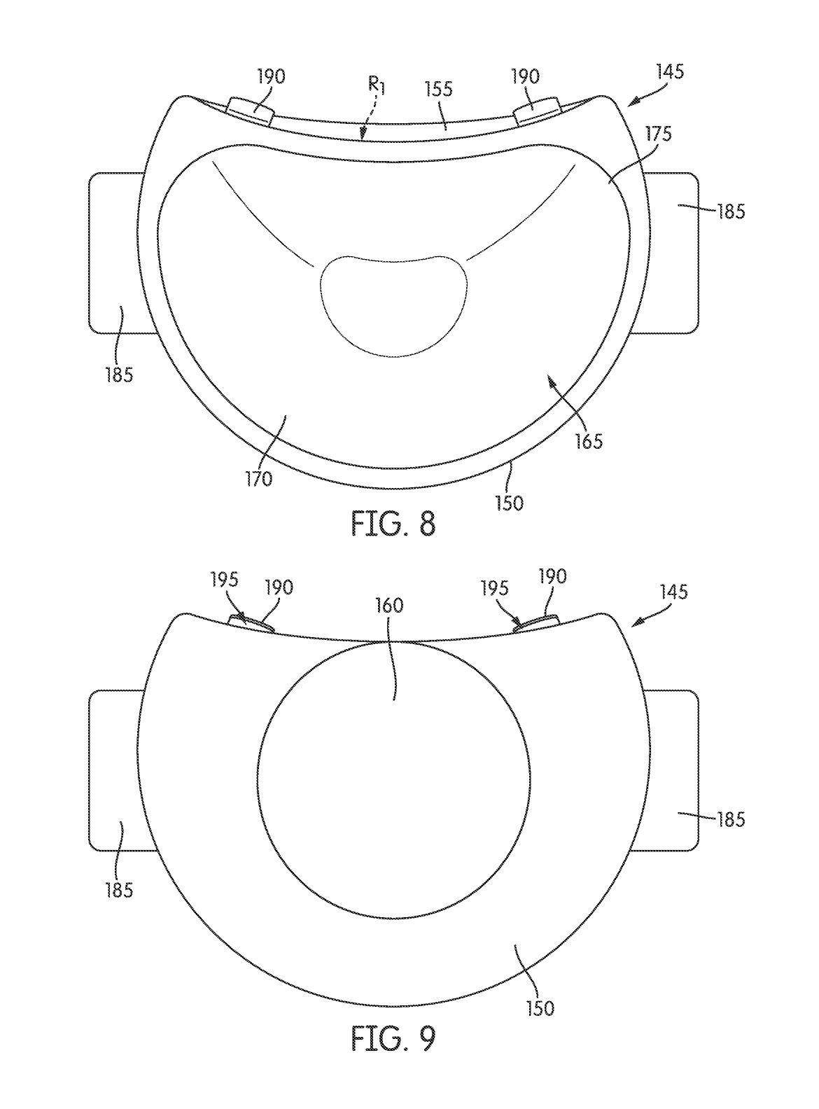

FIGS. 5-9 illustrate the cooking receptacle 145. The cooking receptacle 145 includes an outer surface defined by a front surface 150, a conductive side surface 155, and a bottom surface 160. In addition, a cooking cavity 165 is defined by an inner surface 170 (FIG. 8). The inner surface 170 is a continuous surface defined by an opposite surface of the front surface 150, the bottom surface 160, and the conductive side surface 155. The cooking cavity 165 includes an opening 175 positioned opposite from the bottom surface 160. In the illustrated embodiment, the cooking cavity 165 is a single continuous opening within the cooking receptacle 145. In other embodiments, the cooking cavity 165 may be separated into a plurality of vertical cavities by, for example, dividers. In further embodiments, a plurality of removable inserts may be received within the cooking cavity 165 to separate the cooking cavity 165 into multiple different sized vertical cavities. In further embodiments, a cooking receptacle grate (not shown) may be located adjacent the opening 175 within the cooking cavity 165. The cooking receptacle grate horizontally divides the cooking cavity 165 such that food may be suspended above a bottom surface of the cooking cavity 165.

In the illustrated embodiment, the front surface 150 is defined by a curved surface. In other words, the front surface 150 defines a decreasing radius transitioning from the opening 175 to the bottom surface 160. In other embodiments, the front surface 150 is differently designed. For example, the front surface 150 may include a plurality of flat surfaces extending between the opening 175 and the bottom surface 160. Furthermore, two handles 185 extend from the front surface 150. The handles 185 are positioned oppositely on the cooking accessory 100 near the opening 175 to enable transportation of the cooking accessory 100. In the illustrated embodiment, the handles 185 are a continuous piece of material. In other embodiments, the handles 185 may include an opening able to be gripped. In other embodiments, the cooking receptacle 145 may only include one handle removably coupled to the front surface 150. In other embodiments, the handle may be pivotally attached to the cooking receptacle 145 such that the handle folds down and away from the opening 175. In some embodiments, the handles 185 are manufactured from a thermally non-conductive material such that limited thermal energy propagates to the handles 185.

The bottom surface 160 is a substantially planar surface orientated parallel to the opening 175. The bottom surface 160 enables the cooking receptacle 145 to be stably positioned on a flat surface (e.g., ground, table, appliance grate, etc.) without tipping over onto the front surface 150 or the conductive side surface 155.

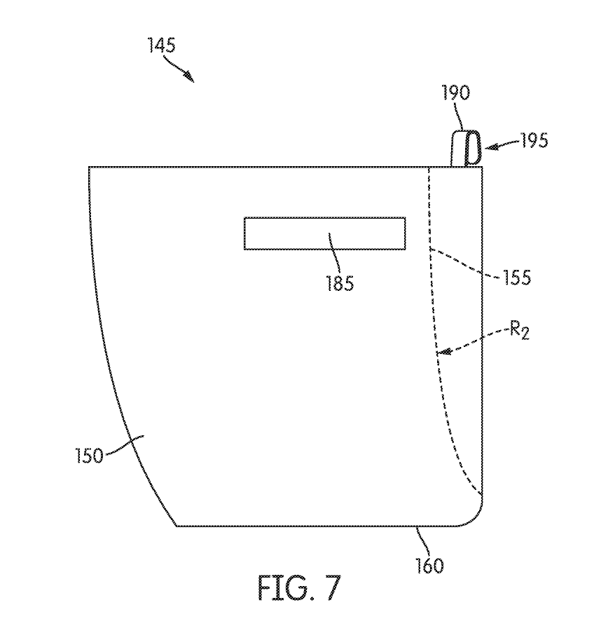

The conductive side surface 155 is generally located between the bottom surface 160 and the opening 175 and defines a side surface of the cooking receptacle 145. The conductive side surface 155 is configured to receive and/or transfer thermal energy, such as conductive and radiant thermal energy. In reference to FIG. 8, the conductive side surface 155 includes a first radius R₁ that is substantially equal to the radius of the rim 130. In the illustrated embodiment, the first radius may vary from about six inches to about fifteen inches. In addition, the conductive side surface 155 includes a second radius R₂ that is substantially equal to the curvature of the base 115 (FIG. 7). The second radius R₂ is generally normal to the first radius R₁. In other embodiments, the conductive side surface 155 may omit the second radius R₂ such that the conductive side surface 155 defines a portion of a cylinder. In further embodiments, for example, with reference to FIG. 1B, the conductive side surface 155 may omit the first and the second radius R₁, R₂ such that the conductive side surface 155 is substantially planar, such that the conductive side surface abuts the base 115′. In other words, the top view (FIG. 8) of the cooking receptacle 145 is generally defined in a shape of the letter “D.” In still further embodiments, the conductive surface 155 may have other shapes, sizes, or configurations to generally match the shape and contour of the outer surfaces of other types of cooking appliances.

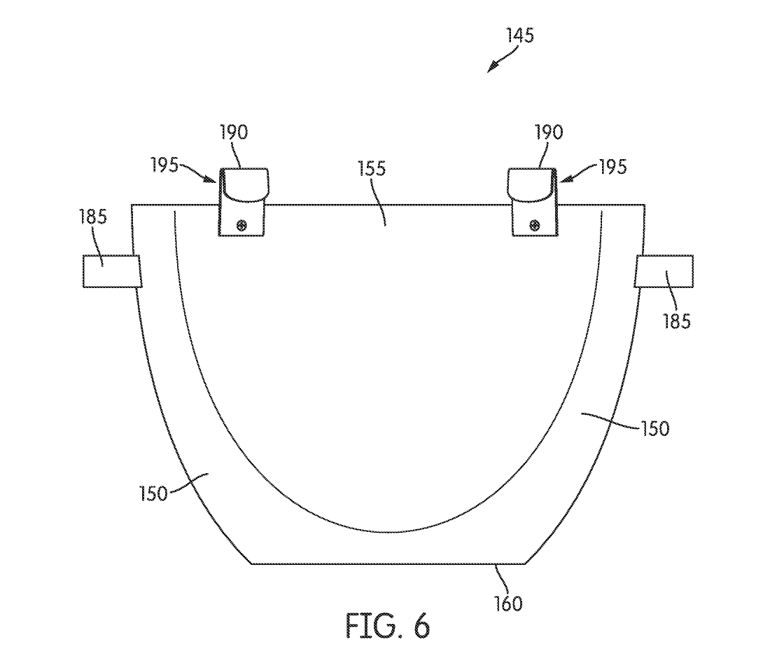

Furthermore, hanging members 190 are coupled to and extend beyond (in a direction opposite from the bottom surface 160) the conductive side surface 155 (FIG. 6). The hanging members 190 are generally located at distal ends of the conductive side surface 155 adjacent the opening 175. The illustrated hanging members 190 are hooks. Each hanging member 190 defines a channel 195 able to receive the rim 130 of the cooking appliance 105. The hanging members 190 enable the cooking accessory 100 to be mechanically coupled to the cooking appliance 105. In other words, the cooking accessory 100 hangs from the rim 130 of the cooking appliance 105 via the hanging members 190. In the illustrated embodiment, the hanging members 190 are secured to the conductive side surface 155 via fasteners. In other embodiments, the hanging members 190 may be secured to the conductive side surface 155 via a welding, brazing, or soldering process. In further embodiments, the hanging members 190 may be in a single integral design positioned generally center on the conductive side surface 155 (i.e., between the handles 185) adjacent the opening 175. In this embodiment, the hanging member is substantially defined by the first radius R₁. In further embodiments, the hanging members 190 may be recessed into the conductive side surface 155. In still further embodiments, the hanging members 190 may be magnets such that the hanging members 190 are electromagnetically attracted to the cooking appliance 110.

In the illustrated embodiment, the cooking receptacle 145 is manufactured from a metallic composition, such as steel. The cooking receptacle 145 is a single integral component manufactured from a single piece of metallic material. In other embodiments, the cooking receptacle 145 may be manufactured from different materials that are able to conduct thermal energy, able to withstand the thermal energy from the cooking appliance 105, and strong enough to hold and secure the food. In further embodiments, the cooking receptacle 145 is manufactured from multiple components and/or materials. In other words, the front surface 150, the bottom surface 160, the conductive side surface 155, and the handles 185 are discrete components coupled together via, for example, a welding process.

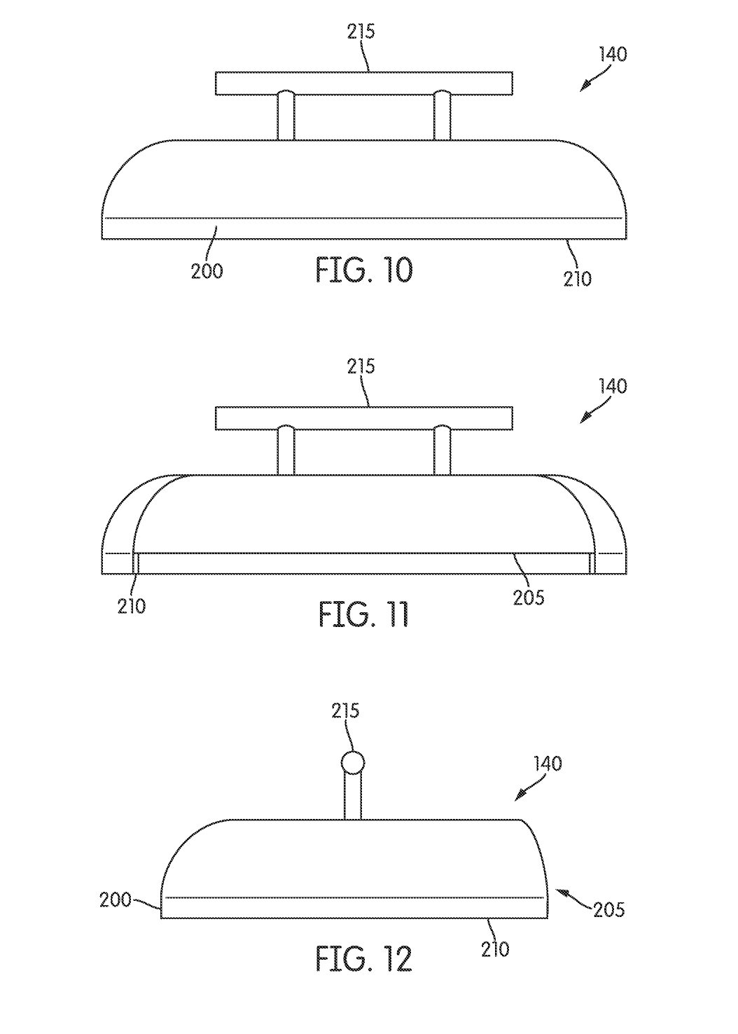

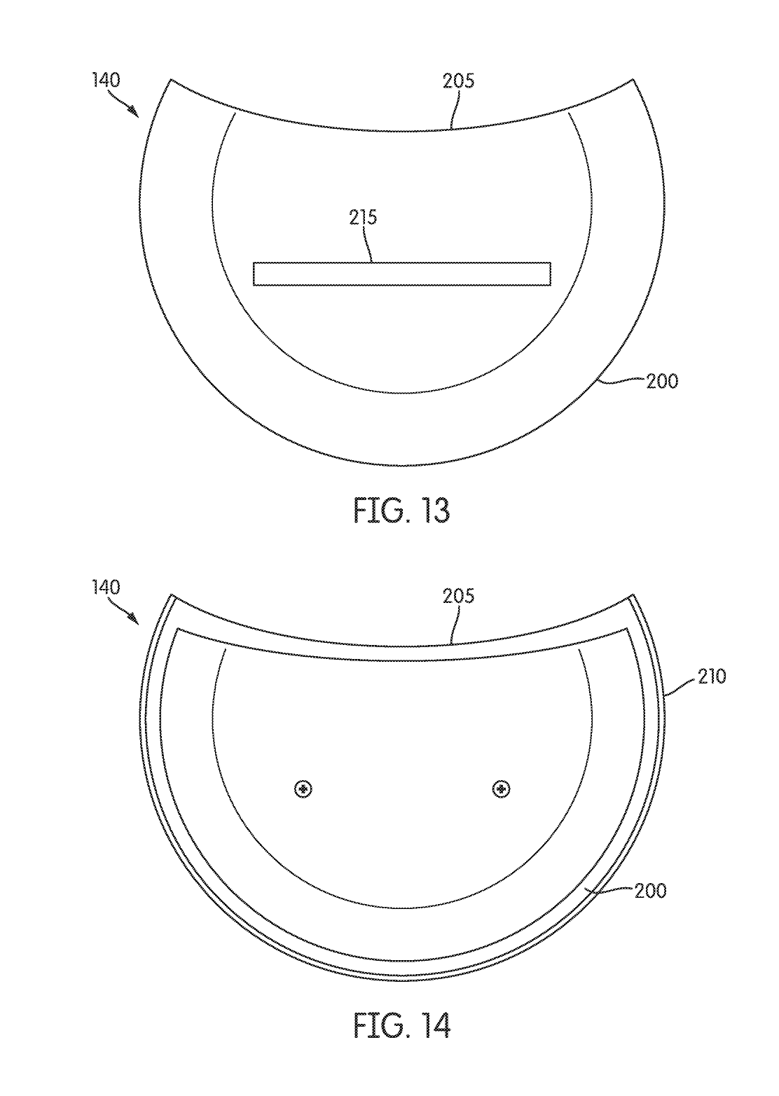

FIGS. 10-14 illustrate the lid 140. The lid 140 is selectively received over the opening 175 of the cooking receptacle 145 to isolate the cooking cavity 165 from the external ambient environment (e.g., temperature, moisture, etc.). The lid 140 includes a front portion 200 that corresponds to the front surface 150 of the cooking receptacle 145 and a rear portion 205 that corresponds to the conductive side surface 155 of the cooking receptacle 145. The front portion 200 includes a geometry substantially equal to the geometry of the front surface 150. Similarly, the rear portion 205 includes a geometry substantially equal to the geometry of the conductive side surface 155. In addition, the front portion 200 includes a lip 210 that extends around the entire perimeter of the front portion 200. The lip 210 is designed to also extend beyond the front surface 150 towards the bottom surface 160. In other embodiments, the lip 210 may extend the entire perimeter of the front portion 200 and the rear portion 205 and may also extend beyond the conductive side surface 155 towards the bottom surface 160. In further embodiments, the geometry of the lid 140 corresponds to the specific geometry of the cooking receptacle 145. In still further embodiments, the lid 140 may be pivotally coupled to the cooking receptacle 145. For example, the lid 140 may be attached to the cooking receptacle 145 by hinges.

In addition, the lid 140 includes a lid handle 215. The lid handle 215 is coupled to the lid 140 via fasteners. In other embodiments, the lid handle 215 may be coupled to the lid 140 via a welding, a brazing, or a soldering process.

In other embodiments of the cooking accessory 100, the cooking accessory 100 may include a thermometer to monitor the temperature of the cooking cavity 165. For example, the thermometer may be coupled to the lid 140, or the thermometer may be coupled to the cooking receptacle 145. In addition, the thermometer may be analog or digital.

In a first mode of operation, the cooking receptacle 145 is physically (e.g., mechanically, magnetically, etc.) attached to the rim 130 of the cooking appliance 105 via the hanging members 190 (FIGS. 1A-B). In other embodiments, the cooking receptacle 145 may be welded to the cooking appliance 105 such that the cooking receptacle 145 is manufactured as a part of the cooking appliance 105. When the cooking accessory 100 is coupled to the cooking appliance 105, the cover 120 of the cooking appliance 105 can be either coupled to the base 115 or detached from the base 115 (FIGS. 1A and 2). In addition, the conductive side surface 155 substantially abuts the exterior surface 125 of the cooking appliance 105. As the cooking appliance 105 is operable (e.g., when the charcoal, wood, or fuel gas is ignited) the cooking appliance 105 primarily transfers thermal energy to the cooking receptacle 145 by thermal conduction (e.g., energy transfer between physically contacting objects) and thermal radiation (e.g., energy transfer by emission of electromagnetic waves). The thermal conduction properties are the primary mechanism (compared to the thermal radiant properties) to convey thermal energy from the cooking appliance 105 to the cooking receptacle 145. Specifically, the direct contact between the conductive side surface 155 and the exterior surface 125 conveys the thermal conductive heat transfer. With respect to thermal radiation, the exterior surface 125 adjacent the cooking receptacle 145—including the exterior surface 125 in contact with the conductive side surface 155—provides the mechanism to convey the thermal radiant heat transfer from the cooking appliance 105 to the cooking receptacle 145.

The thermal conductive heat transfer and radiant heat transfer is driven by a temperature gradient between the cooking appliance 105 and the cooking accessory 100 where the cooking accessory 100 is at a lower temperature than the cooking appliance 105. Thermal energy from the exterior surface 125 of the cooking appliance 105 substantially transfers to the conductive side surface 155 of the cooking receptacle 145. Thermal energy then substantially transfers from the conductive side surface 155 to the inner surface 170. Therefore, it is advantageous to design the cooking receptacle 145—specifically the conductive side surface 155—with a material that thermally conducts energy efficiently such that optimum thermal energy is transferred from the cooking appliance 105 to the cooking accessory 100. Because the inner surface 170 defines the cooking cavity 165, thermal energy from the inner surface 170 is able to transfer into the cooking cavity 165. Many forms of thermal energy transfer may be present to convey thermal energy into the cooking cavity 165. For example, radiant heat transfer will convey thermal energy from the inner surface 170 to the cooking cavity 165. In addition, thermal convection may be observed if a liquid (e.g., water or beer) is within the cooking cavity 165. Furthermore, the food within the cooking cavity 165 may observe conductive heat transfer if the food is in contact with the inner surface 170.

In addition, the user is able to control the temperature and isolate the ambient environment from the cooking cavity 165 by selectively removing the lid 140 from the cooking receptacle 145. With the lid 140 covering the opening 175, thermal energy is isolated within the cooking cavity 165. With the lid 140 displaced from the opening 175, thermal energy is able to escape from the cooking cavity 165 through the opening 175. In other embodiments, the lid 140 may include a vent system (not shown) operable to regulate the thermal energy within the cooking cavity 165. For example, the vent system may include a rotary damper to allow a variable amount of thermal energy to escape from the cooking cavity 165 to regulate the temperature within the cooking cavity 165 without removing the lid 140 from the cooking receptacle 145.

In a second mode of operation, the cooking accessory 100 is placed on the appliance grate 135 and is operable by the user in a similar manner to the first mode of operation. In this configuration, the thermal energy is substantially transferred from the cooking appliance 105 to the cooking accessory 100 through the bottom surface 160. The bottom surface 160 is in direct contact with the appliance grate 135 which yields thermal conductive heat transfer through the bottom surface 160, transferred to the inner surface 170, and ultimately transferred into the cooking cavity 165. Therefore, it is advantageous to design the cooking receptacle 145—specifically the bottom surface 160—also with a material that thermally conducts energy efficiently such that optimum thermal energy is transferred from the cooking appliance 105 to the cooking accessory 100. In addition, thermal radiation produced by the cooking appliance 105 is able to transfer into the cooking cavity 165 via multiple surfaces (i.e., the bottom surface 160, the front surface 150, and the conductive side surface 155).

The user is able to place a variety of desirable food items within the cooking cavity 165 to be cooked, to maintain an optimal food temperature, or as a holding area before the food items are cooked on the cooking appliance 105. For example, the cooking cavity 165 may contain a liquid (e.g., beer, water, etc.) and appropriate garnishes (e.g., salt, pepper, onions, etc.) to simmer bratwurst before the bratwurst are cooked on the cooking appliance 105. In yet another example, beans are able to be heated up within the cooking cavity 165. In yet another example, hotdogs are placed within the cooking cavity 165 to maintain optimal temperature able to be served similar to a serving dish or plate. In other embodiments where the cooking cavity 165 defines multiple cooking cavities, it is now apparent that multiple cooking operations can be carried out in parallel. For example, in a first cavity, beans may be heated up and, in a second cavity, bratwurst may be simmering. In further embodiments where the cooking receptacle grate is within the cooking cavity 165, food may be heated, cooked, or steamed. For example, water may be heated below the cooking receptacle grate in order to steam vegetables and the like.

Various features and advantages of the invention are set forth in the following claims.

1. A cooking accessory, the cooking accessory configured to be selectively coupled to a rim of a cooking appliance, the cooking accessory comprising:
a cooking receptacle configured to physically couple to an exterior of the cooking appliance, the cooking receptacle defining a cooking cavity, the cooking cavity configured to receive food, the cooking receptacle including
an opening,
a bottom surface, and
a conductive side surface configured to abut the exterior surface of the cooking appliance, the conductive side surface enabling thermal energy transfer from the cooking appliance to the cooking cavity, the food within the cooking cavity configured to absorb a portion of the thermal energy.

2. The cooking accessory of claim 1, wherein the cooking receptacle includes a hanging member adjacent the conductive side surface, the hanging member configured to couple the cooking accessory to the cooking appliance.

3. The cooking accessory of claim 1, wherein the cooking receptacle includes a first radius, wherein the first radius is substantially equal to the radius of the rim of the cooking appliance.

4. The cooking accessory of claim 3, wherein the cooking receptacle includes a second radius substantially normal to the first radius, wherein the second radius is substantially equal to a curvature of an outer surface of the cooking appliance.

5. The cooking accessory of claim 1, wherein a lid selectively removable from the cooking receptacle, the lid containing the thermal energy within the cooking receptacle when the lid is coupled to the cooking receptacle.

6. The cooking accessory of claim 1, wherein the bottom surface is selectively placed on an appliance grate within the cooking appliance to enable the thermal energy transfer from the cooking appliance to the cooking cavity.

7. The cooking accessory of claim 1, wherein the cooking appliance is a grill.

8. The cooking accessory of claim 7, wherein the grill is substantially hemispherical.

9. The cooking accessory of claim 7, wherein the grill is substantially a cuboid.

10. A cooking accessory comprising:
an opening;
an outer surface configured to abut an exterior surface of a cooking appliance, the outer surface configured to receive thermal energy from the cooking appliance, the outer surface including
a hanging member configured to selectively couple the cooking accessory to the cooking appliance; and
an inner surface configured to transfer thermal energy from the outer surface to food.

11. The cooking accessory of claim 10, further including a lid selectively received over the opening, the lid including a lip extending around a portion of a perimeter of the lid, wherein the lip extends beyond the opening.

12. The cooking accessory of claim 10, further includes a bottom surface located opposite from the opening, wherein the bottom surface is selectively placed on an appliance grate of the cooking appliance to enable the thermal energy transfer from the cooking appliance to the inner surface.

13. The cooking accessory of claim 10, wherein the cooking appliance is a grill.

14. The cooking accessory of claim 13, wherein the grill is substantially hemispherical.

15. The cooking accessory of claim 13, wherein the grill is substantially a cuboid.

16. The cooking accessory of claim 10, wherein the outer surface includes a first radius, wherein the first radius is substantially equal to the radius of a rim of the cooking appliance.

17. The cooking accessory of claim 16, wherein the outer surface includes a second radius substantially normal to the first radius, wherein the second radius is substantially equal to a curvature of the exterior surface of the cooking appliance.

18. A method of enabling thermal energy transfer from a cooking appliance to a cooking accessory, the cooking accessory including a conductive side surface, the method comprising:
providing a cooking cavity defined within the cooking accessory, the cooking cavity configured to receive food;
physically coupling the cooking accessory to the cooking appliance so that the conductive side surface abuts an outer surface of the cooking appliance, wherein the cooking accessory is thermally dependent on thermal energy of the cooking appliance; and
enabling thermal energy transfer from the cooking appliance to the cooking cavity substantially through the conductive side surface.

19. The method of claim 18, wherein the cooking accessory is selectively removable from a rim of the cooking appliance.

20. The method of claim 18, wherein the cooking appliance is at least one selected from the group comprising a grill having a substantially hemispherical shape and a grill having a substantially cuboid shape.
